(19) United States
(12) Patent Application Publication
(10) Pub. No.: US 2013/0290826 A1
(43) Pub. Date: Oct. 31, 2013

(54) MEDICAL IMAGE DISPLAY APPARATUS AND MEDICAL IMAGE ARCHIVING SYSTEM

(71) Applicants: Toshiba Medical Systems Corporation, Otawara-shi (JP); Kabushiki Kaisha Toshiba, Minato-ku (JP)

(72) Inventors: Kenichi NIWA, Otawara-shi (JP); Hikaru Futami, Nasushiobara-shi (JP); Maiko Tezuka, Nasushiobara-shi (JP); Iwao Goto, Nasushiobara-shi (JP)

(21) Appl. No.: 13/925,958

(22) Filed: Jun. 25, 2013

Related U.S. Application Data
(63) Continuation of application No. PCT/JP2012/083878, filed on Dec. 27, 2012.

(30) Foreign Application Priority Data
Dec. 27, 2011 (JP) 2011-286571

(51) Int. Cl. G06F 17/24

(52) U.S. Cl. CPC G06F 17/241
USPC 715/230

(57) ABSTRACT

According to one embodiment, a medical image display apparatus includes a display unit, an allocation unit, a storage unit. The display unit is configured to display a medical image on which a plurality of annotations are superimposed. The allocation unit is configured to allocate the plurality of annotations to a plurality of groups. The storage unit is configured to store data of at least one annotation belonging to each of the groups in association with data of the medical image on a group basis.

### CROSS REFERENCE TO RELATED APPLICATIONS

This application is a Continuation Application of PCT Application No. PCT/JP2012/083878, filed Dec. 27, 2012 and based upon and claiming the benefit of priority from Japanese Patent Application No. 2011-286571, filed Dec. 27, 2011, the entire contents of all of which are incorporated herein by reference.

### FIELD

Embodiments described herein relate generally to a medical image display apparatus and a medical image archiving system.

### BACKGROUND

Annotation is used as a useful tool for medical image reading (medical image interpretation). Annotation is a collective term of graphical patterns, characters, and symbols attached to medical images to observe medical images again afterward or allow others to observe them. For example, annotation includes a region of interest, straight line, arrow, and measurement result. In addition, annotation data is archived as overlay data complying with the DICOM (Digital Imaging and Communications in Medicine) standard, together with a medical image.

A medical image display apparatus (medical image display software to be also simply referred to as a viewer) for displaying medical images complying with the DICOM standard saves annotation data attached to medical images in a DICOM overlay format. At this time, if a plurality of annotations are attached to the same medical image, the annotations are collectively saved in a single layer in DICOM overlay operation or respectively saved in separate layers for each annotation (or for each annotation shape or effect (shade or the like)). If, for example, shaded arrow annotations are attached to two portions in the same image, the two shaded arrow annotations are collectively saved in one layer or the two shaded arrow annotations are separately saved in four layers. When other users (e.g., radiologists) observe a medical image afterward, the viewer displays all the annotations attached to the medical image while superimposing the annotations on the medical image.

Assume that a user (radiologist or the like) has found a plurality of abnormal shadows in the same image and attached annotations to the abnormal shadows at the time of image reading in a given examination. The user writes medical findings concerning the respective abnormal shadows on a medical finding report. The user then saves the medical image attached with a plurality of annotations as a key image corresponding to each medical finding or embeds a hyperlink in a character string of a medical finding. Another user (radiologist or the like) sometimes observes the medical image while referring to the medical finding report afterward. In this case, the viewer displays all the annotations associated with the medical image upon superimposing them on the medical image. The displayed medical image does not therefore allow another user to clearly grasp the place indicated by each annotation and accurately grasp the contents of the medical finding report. In this case, in order to accurately grasp the contents of the medical finding report, another user inquires of the creator of the medical finding report (the above radiologist) or other well-informed persons about the region of interest of the medical image on which each medical finding of the medical finding report is based.

It is an object of embodiments to provide a medical image display apparatus and medical image archiving system which can improve the accuracy and efficiency of image reading and diagnosis of a medical image attached with a plurality of annotations.

### BRIEF DESCRIPTION OF THE DRAWINGS

FIG. 1 is a block diagram showing the arrangement of a medical image display apparatus according to the first embodiment.

FIG. 2 is a flowchart showing a typical procedure for preprocessing performed under the control of a control unit in FIG. 1.

FIG. 3 is a view for explaining annotation extraction processing performed by a processing unit in step SA1 in FIG. 2.

FIG. 4 is a view for explaining allocation processing performed by the processing unit in step SA2 in FIG. 2.

FIG. 5 is a view for explaining conversion processing and association processing for DICOM overlay data which are performed in steps SA4 and SA5 in FIG. 2.

FIG. 6 is a flowchart showing a typical procedure for postprocessing performed under the control of the control unit FIG. 1.

FIG. 7 is a view for explaining selection processing for a group to which an annotation to be displayed belongs, which is performed by an operation unit in step SB1 in FIG. 6.

FIG. 8 is a view for explaining superimposed image data generation processing and superimposed image data display processing performed in steps SB6 and SB7 in FIG. 6.

FIG. 9 is a block diagram showing the arrangement of a medical image archiving system according to the second embodiment.

FIG. 10 is a block diagram showing the arrangement of a medical image archiving system according to the third embodiment.

FIG. 11 is a view for explaining medical finding report creation processing performed by the medical image archiving system in FIG. 10.

FIG. 12 is a view for explaining medical finding report reference processing performed by the medical image archiving system in FIG. 10.

### DETAILED DESCRIPTION

In general, according to one embodiment, a medical image display apparatus includes a display unit, an allocation unit, and a storage unit. The display unit is configured to display a medical image on which a plurality of annotations are superimposed. The allocation unit is configured to allocate the plurality of annotations to a plurality of groups. The storage unit is configured to store data of at least one annotation belonging to each of the groups in association with data of the medical image on a group basis.

A medical image display apparatus and medical image archiving system according to an embodiment will be described below with reference to the accompanying drawings.

[First Embodiment]

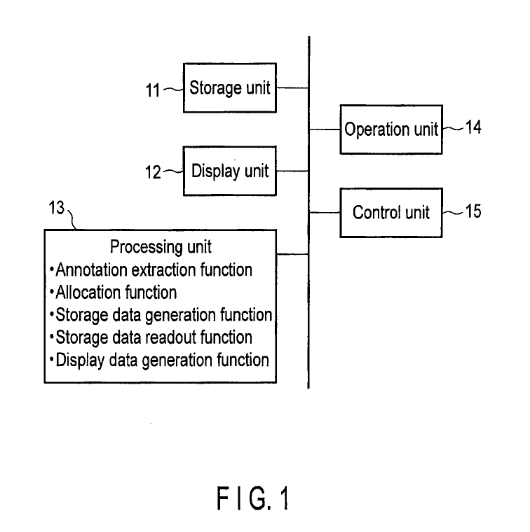

FIG. 1 is a block diagram showing the arrangement of a medical image display apparatus 1 according to the first embodiment. The medical image display apparatus 1 may be a computer apparatus (so-called viewer) for displaying medical images or a computer apparatus (so-called server) for saving and managing medical image data. The medical image display apparatus 1 may be embedded in a medical imaging apparatus for capturing medical images. The medical imaging apparatus corresponds to all existing modalities such as an X-ray diagnostic apparatus, X-ray computed tomography apparatus (CT), magnetic resonance imaging apparatus (MRI), ultrasonic diagnostic apparatus, SPECT apparatus, and PET apparatus.

As shown in FIG. 1, the medical image display apparatus 1 includes a storage unit 11, a display unit 12, a processing unit 13, an operation unit 14, and a control unit 15.

The storage unit 11 stores files in a data format complying with the DICOM (Digital Imaging and Communications in Medicine) standard. More specifically, a file in a format complying with this DICOM standard includes a medical image file. A medical image file includes medical image data and additional information which are associated with each other. Medical image data is formed from the data obtained by encoding a medical image concerning a patient according to the DICOM standard. For example, medical image data is a set of pixel data concerning the respective pixels constituting a medical image. Each pixel data represents the coordinates of each pixel constituting a medical image and a gray value or color value corresponding to the display color of each pixel. Additional information includes information normally used in the DICOM standard, e.g., a patient ID to which medical image data belongs, examination ID, series ID, image ID, image size, and image capture date and time.

The storage unit 11 also stores annotation data in association with medical image data. The annotation data storage formats in this embodiment include a DICOM overlay format and DICOM GSPS (Gray Scale Presentation State) format. According to the DICOM overlay format, annotation data is embedded as DICOM overlay data in a medical image file. According to the DICOM GSPS form, annotation data is embedded as DICOM GSPS data in a medical image file or managed in a file different from a medical image file. Note that annotation is a collective term of graphical patterns, characters, and symbols attached to medical images to observe medical images again afterward or allow others to observe them. For example, annotations include a region of interest, straight line, arrow, and measurement result (graph or the like). The storage unit 11 according to this embodiment stores a plurality of annotation data in association with medical image data for each group made to have a clinical meaning by the user. The storage unit 11 also stores a program for preprocessing to be described later and a program for postprocessing.

The display unit 12 displays, on a display device, a medical image complying with the DICOM standard on which a plurality of annotations complying with the DICOM standard are superimposed. The display image obtained by superimposing annotations on a medical image will be referred to as a superimposed image hereinafter. In this case, the display unit 12 displays a superimposed image in a color mode such as an RGB mode. The display unit to be used includes, for example, a CRT display, liquid crystal display, organic EL display, or plasma display.

The processing unit 13 executes processing under the control of the control unit 15. More specifically, the processing unit 13 has an annotation extraction function, allocation function, storage data generation function, storage data readout function, and display data generation function. With the annotation extraction function, the processing unit 13 extracts a plurality of annotations attached to a medical image by image processing. With the allocation function, the processing unit 13 allocates the plurality of annotations attached to the same medical image to a plurality of groups in accordance with the instruction issued by the user via the operation unit 14 or automatically by image processing. The storage unit 11 stores the data of annotations belonging to the respective groups in association with medical image data for the respective groups. With the storage data generation function, the processing unit 13 converts the data of at least one of the annotations belonging to the respective groups into data for storage. More specifically, data for storage is DICOM overlay data or DICOM GSPS data described above. Data for storage will be simply referred to as storage data hereinafter. With the storage data readout function, the processing unit 13 selectively reads out, from the storage unit 11, the data of annotations belonging to the group selected by the user via the operation unit 14. With the display data generation function, the processing unit 13 converts medical image data and an annotation belonging to each group into display data. More specifically, display data is the data of the image obtained by superimposing the annotation belonging to the group designated by the user via the operation unit 14 on a medical image.

The operation unit 14 accepts various kinds of instructions and information input by the user via input devices. The input devices include pointing devices such as a mouse and a trackball, selection devices such as switch buttons, and a keyboard.

The control unit 15 functions as the main unit of the medical image display apparatus 1, and controls the respective units by reading out programs for preprocessing and postprocessing from the storage unit 11. Preprocessing includes annotation extraction processing performed by the display unit 12, annotation allocation processing performed by the processing unit 13, storage data generation processing performed by the processing unit 13, and annotation storage processing performed by the storage unit 11. Postprocessing includes group selection processing performed by the operation unit 14, storage data readout processing performed by the processing unit 13, display data generation processing performed by the processing unit 13, and superimposed image display processing performed by the display unit 12.

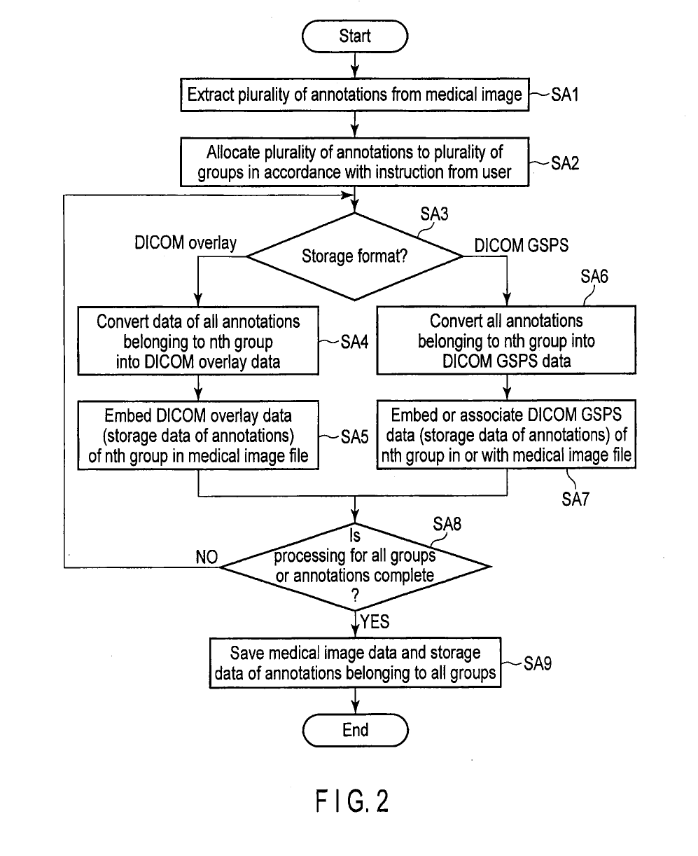

FIG. 2 is a flowchart showing a typical procedure for preprocessing performed under the control of the control unit 15. Assume that a plurality of annotations have been attached to a medical image in accordance with the instruction issued by the user via the operation unit 14 at the start in FIG. 2. Upon completing annotation drawing or inputting operation, the user inputs a request to start storing the medical image and the annotations via the operation unit 14. In response to the input of the start request, the control unit 15 reads out a program for preprocessing from the storage unit 11 and controls the respective units in accordance with the read program.

First of all, the control unit 15 causes the processing unit 13 to perform extraction processing (step SA1). In step SA1, first of all, the processing unit 13 extracts the plurality of annotation data drawn or input to the medical image by image processing.

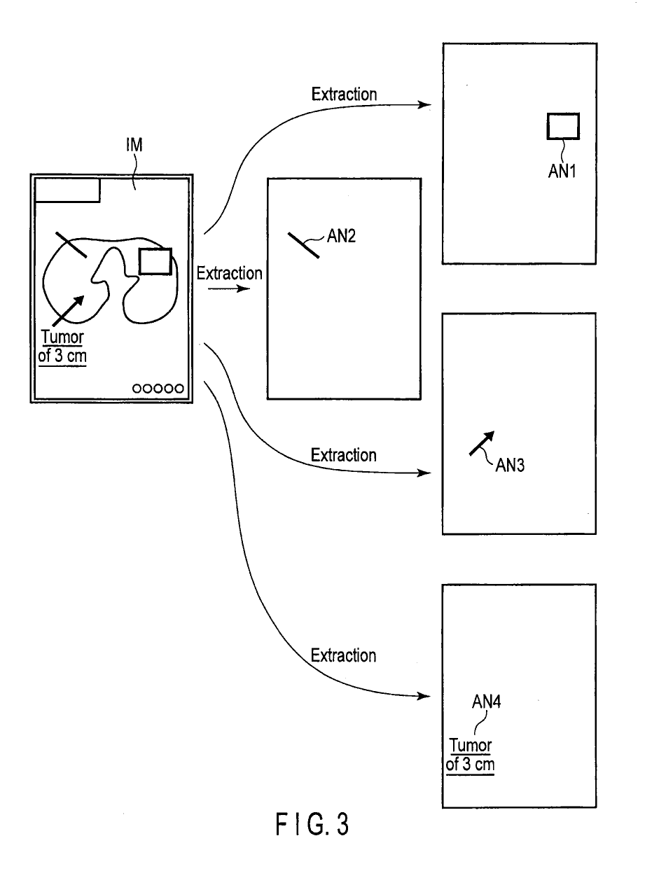

FIG. 3 is a view for explaining annotation extraction processing performed by the processing unit 13. As shown in FIG. 3, a plurality of annotations AN are attached to a medical image IM. Assume that a rectangular frame annotation AN1, a straight line annotation AN2, an arrow annotation AN3, and a character string (“tumor of 3 cm” in FIG. 3) annotation AN4 are attached to the medical image IM. The processing unit 13 separately extracts the annotations AN by existing image processing. For example, the processing unit 13 separately extracts annotations by using the continuity of pixel values, the types of annotations, and the like.

Upon performing step SA1, the control unit 15 causes the processing unit 13 to perform allocation processing (step SA2). In step SA2, the processing unit 13 allocates the plurality of annotations attached to the single medical image to a plurality of groups in accordance with the instruction issued by the user via the operation unit 14. The user classifies the respective annotations in accordance with the indicated anatomical region and the like according to his/her decision, and allocates the annotations to groups corresponding to the anatomical region and the like. For example, at least one annotation set for one medical founding is allocated to one group. The number of groups may be smaller than the number of annotations.

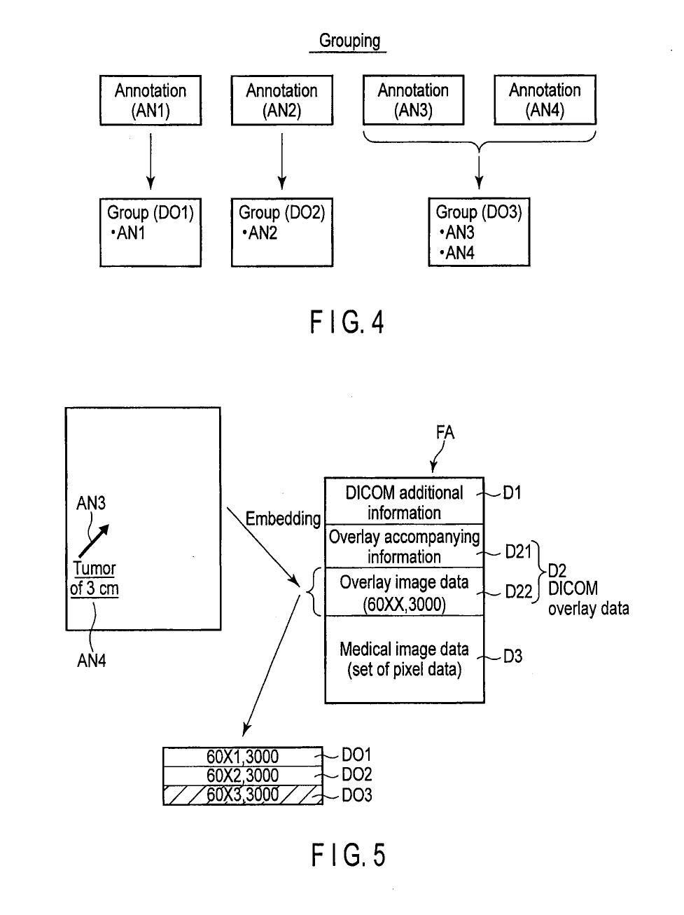

FIG. 4 is a view for explaining allocation processing performed by the processing unit 13. Assume that as shown in FIG. 4, four annotations (annotations AN1, AN2, AN3, and AN4) are attached to a medical image. In general, one or a plurality of annotations AN may be attached to a clinical region of interest. The user allocates the annotations AN to groups DO via the operation unit 14. For example, the annotations AN are grouped according to the anatomical regions to which the annotations AN are attached. More specifically, assume that the annotation AN1 is attached to the right upper lobe of the lung on the back side, the annotation AN2 is attached to the left upper lobe of the lung on the back side, and the annotations AN3 and AN4 are attached to the left upper lobe of the lung on the abdominal side. In this case, it is preferable that the annotation AN1 is allocated to a group DO1, the annotation AN2 is allocated to a group DO2, and the annotations AN3 and AN4 are allocated to a group DO3.

Note that a plurality of annotations may be automatically allocated to a plurality of groups by image processing. For example, annotations may be automatically allocated to groups in accordance with the input order of the annotations and the positions of the annotations on a medical image. When performing allocation by image processing, the user may confirm the allocation of the annotations to the groups by issuing a confirmation instruction via the operation unit 14. This allows the user to check the validity of automatic allocation by image processing.

Upon performing step SA2, the control unit 15 waits for the designation of the DICOM overlay format or DICOM GSPS format as the storage format of the annotation belonging to the nth (n≧1) group (step SA3). For example, the user designates, via the operation unit 14 for each group, whether to store an annotation in the DICOM overlay format or DICOM GSPS format. Note that the designation of a storage format is not limited by designation by the user via the operation unit 14. For example, the control unit 15 may automatically designate a preset one of the DICOM overlay format and the DICOM GSPS format as the storage format of the annotation belonging to the nth group.

If the user designates the DICOM overlay format as a storage format (“DICOM overlay” in step SA3), the control unit 15 causes the processing unit 13 to perform conversion processing to DICOM overlay data (step SA4). In step SA4, the processing unit 13 converts the data of the annotation belonging to the nth group whose storage format is designated into DICOM overlay data.

Upon performing step SA4, the control unit 15 causes the processing unit 13 to perform association processing (step SA5). In step SA5, the processing unit 13 associates the DICOM overlay data of the annotation belonging to the nth group with the data of the medical image complying with the DICOM standard. More specifically, the processing unit 13 embeds the DICOM overlay data of the annotation belonging to the nth group in the medical image file. This associates the DICOM overlay data of the annotation belonging to the nth group with the data of the medical image.

FIG. 5 is a view for explaining conversion processing and association processing for DICOM overlay data which are performed by the processing unit 13. Note that FIG. 5 shows a concrete example of conversion processing and association processing for the data of the annotation belonging to the group DO3 in FIG. 4. The processing unit 13 performs conversion processing and association processing for other groups in the same manner.

As shown in FIG. 5, when storing annotation data as DICOM overlay data, the processing unit 13 converts the annotation data into DICOM overlay data complying with the DICOM standard and embeds the data in a medical image file FA. As shown in FIG. 5, the medical image file FA in the DICOM overlay format has data items including DICOM additional information D1, DICOM overlay data D2, and medical image data D3 associated with each other. As described above, the medical image file FA embeds the DICOM overlay data D2.

As shown in FIG. 5, the DICOM overlay data D2 is generated based on the annotations extracted by the processing unit 13. The DICOM overlay data D2 includes overlay accompanying information D21 and overlay image data D22. The overlay accompanying information D21 includes accompanying information concerning annotations such as the color values of the display colors of the annotations, their matrix sizes (XY sizes), and reference positions. The overlay image data D22 is defined by 1-bit information for each pixel. That is, the overlay image data D22 includes information indicating whether each pixel is an annotation pixel. The overlay image data D22 is bitmap data or character string data representing the spatial distribution of annotations, which is encoded according to the DICOM standard and managed by data element tags (60XX, 3000) defined in the DICOM standard. Note that bitmap data is encoded into an OB (Other Binary String) of VR (Value Representation) in the DICOM standard, whereas character string data is encoded into an OW (Other Word String) of VR.

As shown in FIG. 5, the overlay image data D22 is managed for each group. A storage area for overlay image data for each group will be referred to as a layer DO. For example, the overlay image data of the annotations AN3 and AN4 belonging to the same group are stored in a layer DO3. Likewise, the overlay image data of the annotation AN1 is stored in a layer DO1, and the overlay image data of the annotation AN2 is stored in a layer DO2. The layer belonging to the nth group is managed by a data element tag (60Xn, 3000).

In step SA3, the processing unit 13 generates DICOM overlay data based on the data of all the annotations belonging to the nth group. In step SA4, the processing unit 13 associates the DICOM overlay data of all the annotations belonging to the nth group with medical image data. This associates the data of all the annotations belonging to the nth group with the medical image data.

In this manner, the processing unit 13 hierarchically embeds the DICOM overlay data of a plurality of annotations in a medical image file in a format complying with the DICOM standard described above upon discriminating the annotations on a group basis.

Note that one annotation may be divided and embedded in two or more layers. For example, bitmap data representing a spatial distribution concerning the shape of the annotation AN1 and bitmap data representing a spatial distribution concerning an effect such as the shade of the annotation AN1 may be separately embedded in two different layers. That is, in this case, the annotation AN1 is expressed by the combination of the overlay image data D22 embedded in the two layers. If it is not possible to embed all annotations in the layers attached with data element tags (60XX, 3000) defined and managed by the DICOM standard, it is possible to embed each annotation in the storage area attached with a privately defined unique identifier (private tag), in which any types of data are not reserved to be embedded by the DICOM standard. It is sometimes impossible, according to the DICOM standard, to embed overlays more than 16 in DICOM overlay data. When embedding annotations in storage areas attached with private tags, the annotations are embedded in the storage areas attached with the private tags upon being discriminated on a group basis by the same method as that of embedding annotation data in data element tags (60XX, 3000) defined by the DICOM standard described above.

If the user designates in step SA3 to store the data in the DICOM GSPS format (“DICOM GSPS” in step SA3), the control unit 15 causes the processing unit 13 to perform conversion processing to DICOM GSPS data (step SA6). In step SA6, the processing unit 13 converts the annotation data belonging to the nth group whose storage format is designated into DICOM GSPS data. More specifically, first of all, the processing unit 13 specifies the shape and position of the annotation belonging to the nth group by image processing. The position of an annotation is defined by the coordinates of a plurality of feature points determined by the shape of the annotation in advance. If, for example, an annotation is rectangular (AN1 in FIG. 3), the coordinates of a plurality of feature points are defined by the coordinates of four vertices. The processing unit 13 then encodes the specified shape and position of the annotation according to the DICOM GSPS data format. The data generated by this encoding operation is handled as DICOM GSPS data.

Upon performing step SA6, the control unit 15 causes the processing unit 13 to perform association processing (step SA7). In step SA7, the processing unit 13 associates the DICOM GSPS data of the annotation belonging to the nth group with medical image data complying with the DICOM standard. More specifically, the processing unit 13 sets the DICOM GSPS data of the annotation belonging to the nth group in a medical image file. Alternatively, the processing unit 13 associates a file storing DICOM GSPS data with a medical image file.

Upon performing step SA5 or SA7, the control unit 15 determines whether data conversion processing and association processing have been performed for all the groups or annotations (step SA8).

Upon determining that data conversion processing and association processing have not been performed for all the groups or annotations (NO in step SA8), the control unit 15 advances to step SA3 to wait for the designation of a storage format for another group. The control unit 15 then sequentially performs steps SA3, SA4, SA5, and SA8 or SA3, SA6, SA7, and SA8 in the order named by the same method as described above until the control unit 15 determines in step SA8 that data conversion processing and association processing have been performed for all the annotations.

Upon determining in step SA8 that data conversion processing and association processing have been performed for all the groups or annotations (YES in step SA8), the control unit 15 causes the storage unit 11 to perform storage processing (step SA9). In step SA9, the storage unit 11 stores the storage data (DICOM overlay data or DICOM GSPS data) of a plurality of annotations associated on a group basis and medical image data.

Upon performing step SA9, the control unit 15 terminates the preprocessing.

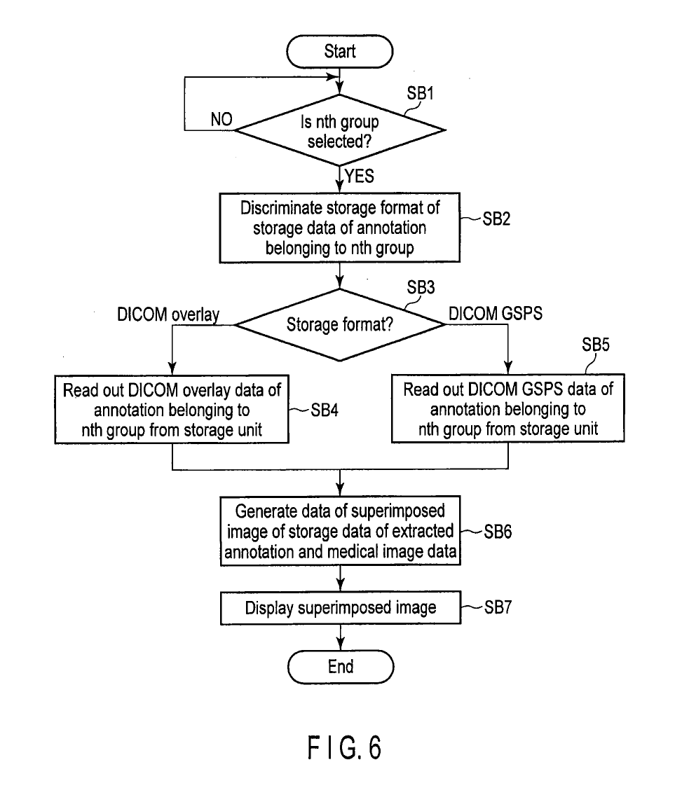

Postprocessing performed under the control of the control unit 15 will be described next. FIG. 6 is a flowchart showing a typical procedure for postprocessing performed under the control of the control unit 15.

As shown in FIG. 6, first of all, the control unit 15 waits for the selection of the nth group (step SB1). In step SB1, a group to which an annotation to be displayed belongs is selected as the nth group. More specifically, the user designates a medical image file embedding the data of a medical image to be observed, via the operation unit 14, at a stage prior to step SB1. The display unit 12 reads out the medical image data embedded in the designated medical image file and displays the medical image corresponding to the read data. No annotation is attached to the displayed medical image. The user then selects, via the operation unit 14, a group to which the annotation to be displayed belongs.

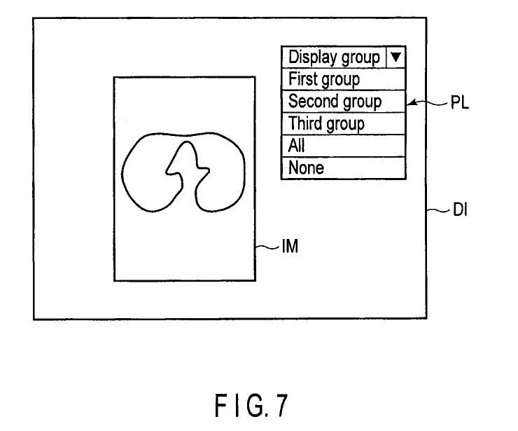

FIG. 7 is a view for explaining the selection of a group to which an annotation to be displayed belongs. As shown in FIG. 7, the display unit 12 displays a window DI including the medical image IM. The window DI displays a pulldown menu PL for the selection of a group in addition to the medical image IM. The pulldown menu PL displays a list of the identifiers and the like of groups of annotations associated with the data of the medical image IM. The pulldown menu PL may also display the item “all” for the display of all annotations, the item “none” for the erasure of the annotations superimposed on a medical image, and the like. The user selects an item corresponding to a desired group from the groups displayed on the pulldown menu PL via the operation unit 14. Note that the pulldown menu PL may display not only the numbers of the groups but also titles expressing the contents of medical findings indicated by the annotations stored in the respective groups. If, for example, an annotation belonging to the first group is attached to a medical finding concerning a tumor (or abnormal shadow) on the right upper lobe of the lung on the back side, it is preferable to display a title like “tumor on right upper lobe” instead of “first group”. The user can arbitrarily set a title via the operation unit 14.

Upon performing step SB1, the control unit 15 causes the processing unit 13 to perform discrimination processing (step SB2). In step SB2, the processing unit 13 discriminates the storage format of the storage data of the annotation belonging to the nth group selected in step SB1. For example, the processing unit 13 analyzes the storage data of the annotation belonging to the nth group stored in the storage unit 11. If the storage data is DICOM overlay data, the processing unit 13 discriminates the storage format as the DICOM overlay format. If the storage data is DICOM GSPS data, the processing unit 13 discriminates the storage format as the DICOM GSPS format.

Upon discriminating in step SB2 that the storage format is the DICOM overlay format (“DICOM overlay” in step SB3), the control unit 15 causes the processing unit 13 to perform DICOM overlay data readout processing (step SB4). In step SB4, the processing unit 13 reads out the DICOM overlay data of the annotation belonging to the nth group selected in step SB1 from the storage unit 11. More specifically, the processing unit 13 reads out DICOM overlay data from the layer of the annotation belonging to the nth group which is embedded in the medical image file to which the displayed medical image data belongs.

Upon discriminating in step SB2 that the storage format is the DICOM GSPS format (“DICOM GSPS” in step SB3), the control unit 15 causes the processing unit 13 to perform DICOM GSPS data readout processing (step SB5). In step SB5, the processing unit 13 reads out the DICOM GSPS data of the annotation belonging to the nth group selected in step S1 from the storage unit 11. If the DICOM GSPS data is embedded in a medical image file, the processing unit 13 reads out the DICOM GSPS data concerning the annotation belonging to the nth group from the medical image file to which the displayed medical image data belongs. If the DICOM GSPS data is managed and stored in a file different from a medical image file, the processing unit 13 reads out the file of the DICOM GSPS data associated with the medical image file to which the displayed medical image data belongs from the storage unit 11.

Upon performing step SB4 or SB5, the control unit 15 causes the processing unit 13 to perform superimposed image generation processing (step SB6).

In step SB6, the processing unit 13 generates superimposed image data by performing superimposition processing for the storage data (DICOM overlay data or DICOM GSPS data) of the read annotation and the medical image data. The processing in step SB6 will be described later.

Upon performing step SB6, the control unit 15 causes the display unit 12 to perform display processing (step SB7). In step SB7, the display unit 12 displays the superimposed image corresponding to the data generated in step SB6.

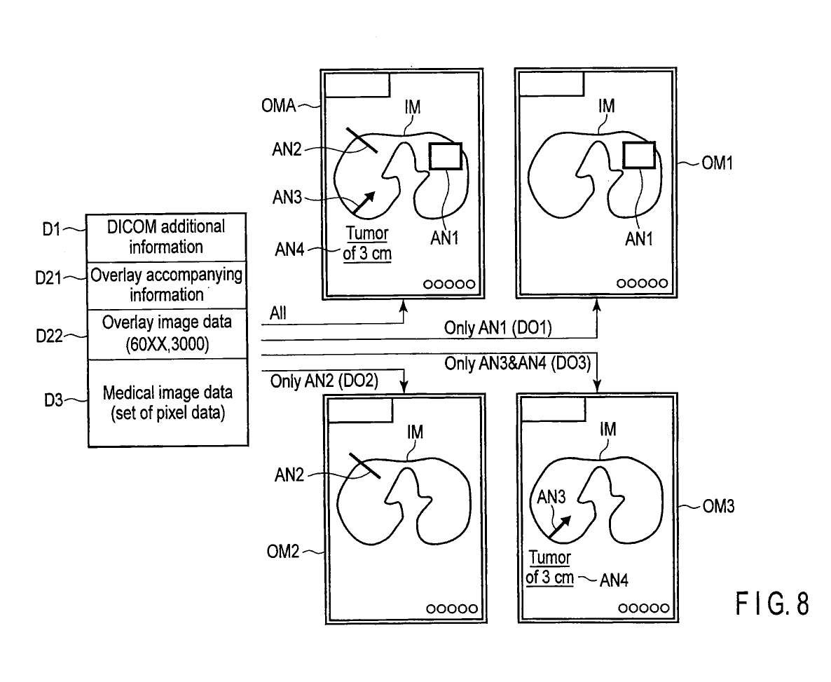

FIG. 8 is a view for explaining superimposed image data generation processing and superimposed image display processing. Assume that the user has selected the first group DO1 (annotation AN1) via the operation unit 14, and the annotation AN1 has been stored in the DICOM overlay format. In this case, the processing unit 13 extracts the DICOM overlay data (overlay accompanying information D21 and overlay image data D22) concerning the annotation AN1 from the medical image file. The processing unit 13 then generates the display data of the annotation AN1 in accordance with the overlay accompanying information D21 and overlay image data D22 concerning the annotation AN1. The processing unit 13 generates the data of a superimposed image OM1 of the annotation AN1 and the medical image based on the display data of the annotation AN1 and the medical image data. As shown in FIG. 8, the superimposed image OM1 is the display image formed by selectively superimposing only the annotation AN1 belonging to the first group DO1 on the medical image IM. The display unit 12 displays the superimposed image OM1.

Likewise, when the user has selected the second group DO2, the third group DO3, or all the groups DO1, DO2, and DO3, the processing unit 13 performs steps SB1, SB2, SB3, SB4, SB6, and SB7 or steps SB1, SB2, SB3, SB5, SB6, and SB7 in the order named to display a superimposed image OM2, superimposed image OM3, or superimposed image OMA. Note that the superimposed image OM2 is the display image formed by selectively superimposing the medical image IM and the annotation AN2 belonging to the second group. The superimposed image OM3 is the display image formed by selectively superimposing the medical image IM and the annotations AN3 and AN4 belonging to the third group. The superimposed image OMA is the display image formed by superimposing the medical image IM and the annotations AN1, AN2, AN3, and AN4.

Note that it is preferable to allow the user to designate to display or not display annotation. For example, it is preferable to display an annotation display button and an annotation non-display button on a display window. When the user presses the non-display button, the annotation superimposed on a medical image is erased from the window, and the original medical image is displayed. When the user presses the display button, the annotation belonging to the group selected by the user is superimposed and displayed on the medical image again. This improves the utility and accuracy of the observation, image reading, and diagnosis of medical images by the user.

Upon performing step SB7, the control unit 15 terminates the postprocessing.

Note that in the postprocessing described above, the control unit 15 reads out the storage data of an annotation upon discriminating the storage data of the annotation. However, this embodiment is not limited to this. For example, the control unit 15 may read out the storage data of the annotation belonging to a selected group first and then analyze the read storage data to discriminate whether the storage data is in the DICOM overlay format or DICOM GSPS format.

As described above, the medical image display apparatus 1 according to the first embodiment includes the display unit 12, the processing unit 13, and the storage unit 11. The display unit 12 displays a medical image on which a plurality of annotations are superimposed. The processing unit 13 allocates the plurality of annotations to a plurality of groups. For example, the processing unit 13 allocates the plurality of annotations to the plurality of groups based on at least one of the anatomical region to which each annotation is attached, the medical finding indicated by each annotation, the input order of the respective annotations, and the position of each annotation on the medical image. The storage unit 11 stores the storage data of at least one annotation belonging to each of a plurality of groups in association with medical image data on a group basis.

With this arrangement, the medical image display apparatus 1 according to the first embodiment can allocate a plurality of annotations to a plurality of groups each having a clinically common characteristic and store and read out the annotations on a group basis. Therefore, when the user selects a group of interest from the plurality of groups, the medical image display apparatus 1 can selectively extract only the annotation belonging to the selected group, of the plurality of annotations associated with the medical image, from the storage unit 11 and display the extracted annotation upon superimposing it on the medical image. The user can therefore easily discriminate annotations and easily grasp the abnormal shadows and the like indicated by the annotations. Note that since the medical image including annotations which is generated by this arrangement is a medical image file in a format complying with the DICOM standard, this apparatus, like a conventional viewer, can transmit a medical image file to a system or apparatus complying with the DICOM standard by communication complying with the DICOM standard and display the annotations attached to the medical image although it cannot selectively display annotations.

According to the first embodiment, it is possible to improve the accuracy and efficiency of image reading and diagnosis of a medical image attached with a plurality of annotations.

[Second Embodiment]

The first embodiment has exemplified the medical image display apparatus implemented by a single computer apparatus. The second embodiment will exemplify a medical image archiving system constituted by a medical image display apparatus and a medical image archiving apparatus. The same reference numerals denote constituent elements having the same functions as those in the first embodiment, and a repetitive description will be made only when required.

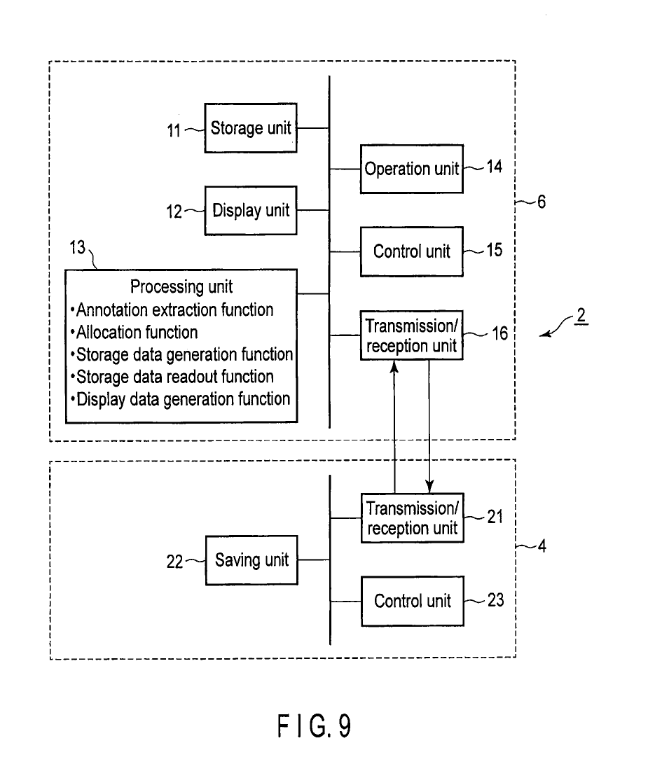

FIG. 9 is a block diagram showing the arrangement of a medical image archiving system 2 according to the second embodiment. As shown in FIG. 9, the medical image archiving system 2 includes a medical image display apparatus 3 and a medical image archiving apparatus 4 which are connected to each other via a network. The medical image display apparatus 3 corresponds to a so-called viewer, and the medical image archiving apparatus 4 corresponds to a so-called server. In this manner, the medical image display apparatus 3 and the medical image archiving apparatus 4 constitute a PACS (Picture Archiving and Communication System). Note that the medical image display apparatus 3 may be embedded in a medical imaging apparatus for capturing medical images. This medical imaging apparatus corresponds to any types of existing modalities including an X-ray diagnostic apparatus, X-ray computed tomography apparatus (CT), magnetic resonance imaging apparatus (MRI), ultrasonic diagnostic apparatus, SPECT apparatus, and PET apparatus.

As shown in FIG. 9, the medical image display apparatus 3 includes a storage unit 11, a display unit 12, a processing unit 13, an operation unit 14, a control unit 15, and a transmission/reception unit 16.

The transmission/reception unit 16 transmits the data of a medical image and the storage data (DICOM overlay data or DICOM GSPS data) of the annotations attached to the medical image to the medical image archiving apparatus 4 via a network by a communication scheme complying with the DICOM standard. More specifically, the transmission/reception unit 16 transmits the data of a plurality of annotations allocated to a plurality of groups by the processing unit 13 to the medical image archiving apparatus 4 on a group basis. The transmission/reception unit 16 also receives the data transmitted from the medical image archiving apparatus 4. The control unit 15 controls the transmission/reception of each data by the transmission/reception unit 16.

As shown in FIG. 9, the medical image archiving apparatus 4 includes a transmission/reception unit 21, a saving unit 22, and a control unit 23.

The transmission/reception unit 21 receives the data of a medical image and the storage data (DICOM overlay data or DICOM GSPS data) of the annotations attached to the medical image transmitted from the medical image display apparatus 3 via a network by a communication scheme complying with the DICOM standard. The transmission/reception unit 21 also reads out the data of the medical image and the storage data of the annotations from the saving unit 22 and transmits them to the medical image display apparatus 3 in accordance with the request issued by the user via the operation unit 14 of the medical image display apparatus 3. More specifically, the transmission/reception unit 21 reads out the storage data of the annotation belonging to the nth group from the saving unit 22 and transmits the data to the medical image display apparatus 3 when the user selects and designates the nth group via the operation unit 14. The transmitted data of the medical image is superimposed on the storage data of the annotations to generate image data. The display unit 12 then displays the superimposed image corresponding to the generated data.

The saving unit 22 saves the received data of the medical image and the storage data of the plurality of annotations in association with each other. In this case, the saving unit 22 saves, for each of a plurality of groups, the data of the annotation belonging to each group in association with the medical image data on a group basis.

The control unit 23 controls the transmission/reception unit 21 and the saving unit 22.

The medical image archiving system 2 according to the second embodiment executes preprocessing and postprocessing in the same manner as that in the first embodiment. A detailed description of preprocessing and postprocessing will be omitted.

The second embodiment can therefore improve the accuracy and efficiency of interpretation and diagnosis of a medical image attached with a plurality of annotations.

[Third Embodiment]

The second embodiment has exemplified the medical image archiving system constituted by the medical image display apparatus and the medical image archiving apparatus. The third embodiment will exemplify a medical image display apparatus 3 embedding a medical finding report creation function. The same reference numerals denote constituent elements having the same functions as those in the first and second embodiments, and a repetitive description will be made only when required.

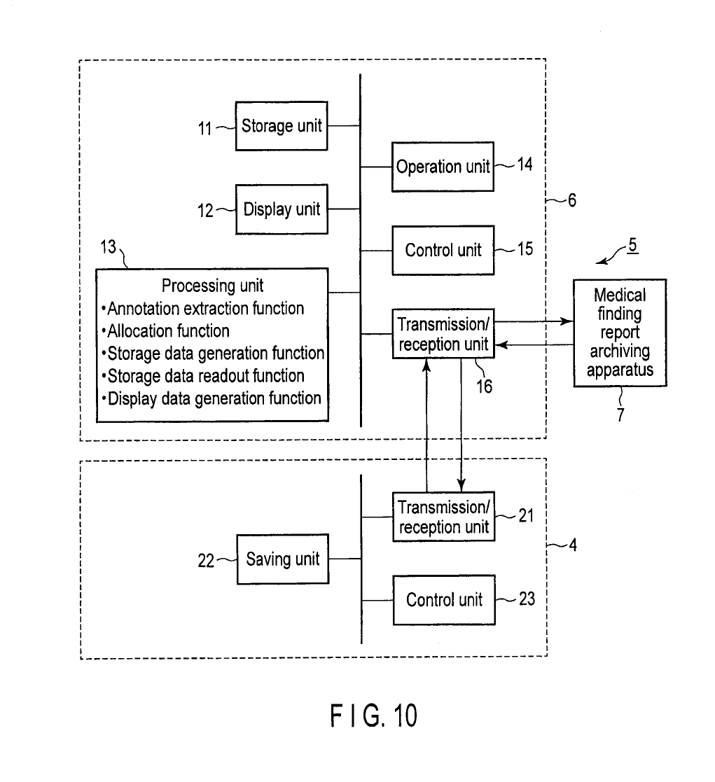

FIG. 10 is a block diagram showing the arrangement of a medical image archiving system 5 according to the third embodiment. The medical image archiving system 5 includes a medical image display apparatus 6, a medical image archiving apparatus 4, and a medical finding report archiving apparatus 7. The medical image display apparatus 6 and the medical finding report archiving apparatus 7 are connected to each other via a network.

The medical image display apparatus 6 according to the third embodiment includes a storage unit 11, a display unit 12, a processing unit 13, an operation unit 14, a control unit 15, and a transmission/reception unit 16.

The storage unit 11 stores a program for creating a medical finding report in addition to a program for operating a medical image and a program for generating a superimposed image.

The display unit 12 displays, on a display device, a window for the creation of a medical finding report in addition to a window for displaying a medical image. The third embodiment is provided with two or more display devices. Typically, the display unit 12 displays, on different display devices, a window for displaying a medical image and a window for creating a medical finding report. These display devices are connected to the medical image display apparatus 6. The display unit 12 can display a completed medical finding report on the display device.

The processing unit 13 further has a medical finding report creation function. With the medical finding report creation function, the processing unit 13 creates a medical finding report concerning a medical image in accordance with the instruction issued by the user via the operation unit 14. For example, the processing unit 13 associates, for each group, a medical image and the annotation belonging to each group to a key image clinically corresponding to each group or a character string of a medical finding on a group basis. The storage unit 11 stores the medical image data and the annotation data which are associated with each other.

The transmission/reception unit 16 transmits the medical finding report created by the processing unit 13 to the medical finding report archiving apparatus 7 via a network. The transmission/reception unit 16 receives the medical finding report from the medical finding report archiving apparatus 7.

The control unit 15 functions as the main unit of the medical image display apparatus 6. The control unit 15 reads out a program for operating a medical image, a program for generating a superimposed image, and a program for creating a medical finding report from the storage unit 11 and controls the respective units. When the above programs are read out, the display unit 12 displays a window for displaying a medical image and a window for creating a medical finding report.

An example of the operation of the medical image archiving system 5 according to the third embodiment will be described next. The processing according to the third embodiment is roughly classified into medical finding report creation processing and medical finding report reference processing.

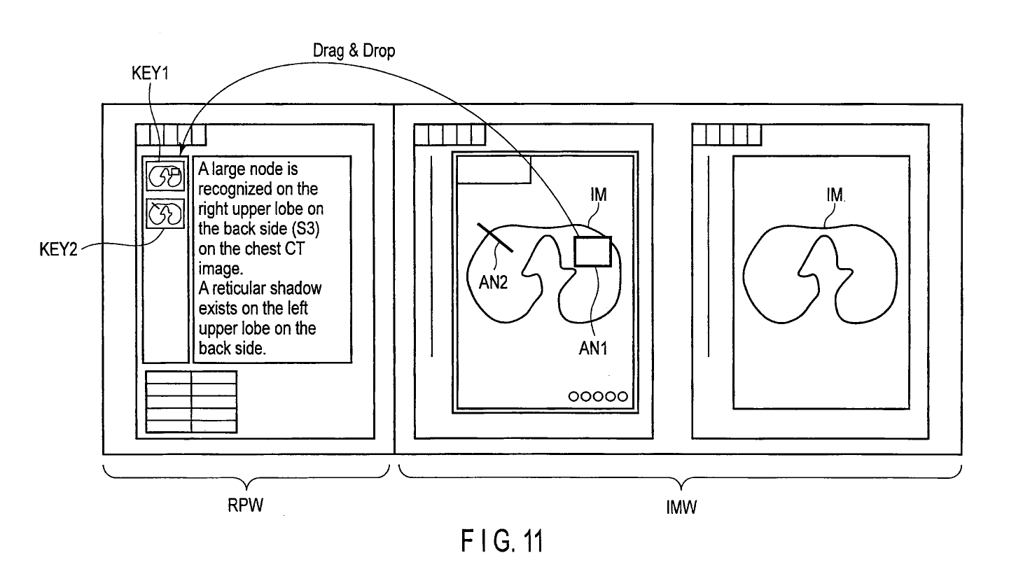

Medical finding report creation processing will be described first with reference to FIG. 11. As shown in FIG. 11, the display unit 12 displays a window IMW for displaying the medical image IM on the right side and a window RPW for creating a medical finding report on the left side in response to the selection of examination on an interpretation target by the user via the operation unit 14. Typically, different display devices display the window IMW and the window RPW. For example, upon finding an abnormal shadow by interpreting a medical image IM, the user draws an annotation AN1 on the medical image IM and inputs a medical finding concerning the abnormal shadow (“a large node is recognized on the right upper lobe of the lung on the back side (S3) on the chest CT image”) via the operation unit 14, as shown in FIG. 11. Note that the user inputs medical findings concerning a medical finding report via the operation unit 14, the processing unit 13 writes the findings on the medical finding report, and the display unit 12 displays the report.

The user associates (hyperlinks) a medical image as a basis for the medical findings written on a medical finding report with a character string of the medical findings written on the medical finding report or a key image via the operation unit 14 so as to refer to the medical image and the medical finding report again afterward or allow others to refer to them afterward. The control unit 15 causes the processing unit 13 to perform association processing in response to, for example, the association operation for a key image KEY concerning a given medical finding via the operation unit 14. The associating operation corresponds to, for example, the operation of dragging and dropping an annotation AN onto the key image KEY with the mouse of the operation unit 14. In association processing, the processing unit 13 associates medical image data, at least one annotation AN concerning this medical finding, and the key image having undergone the associating operation. More specifically, the processing unit 13 associates a hyperlink linking the medical image IM and a hyperlink linking the annotation AN with the key image KEY. The storage unit 11 stores the data of the medical image IM, the data of the annotation AN1, and the key image KEY in association with each other. The data of the medical image IM is associated with the data of the annotation AN in the same manner as in the first and second embodiments. Note that a plurality of annotations may be associated with one key image KEY. The processing of associating the data of a medical image, the data of at least one annotation AN concerning this medical finding, and the key image having undergone associating operation corresponds to the processing of allocating a plurality of annotations to a plurality of groups in the first and second embodiments. That is, one medical finding corresponds to a group in the first and second embodiments.

In addition, the control unit 15 causes the processing unit 13 to perform association processing in response to, for example, the associating operation performed by the operation unit 14 concerning a character string (e.g., “node” or “reticular shadow”) of a given medical finding. The associating operation corresponds to, for example, the operation of dragging and dropping the annotation AN onto a character string with the mouse of the operation unit 14. In association processing, the processing unit 13 associates the medical image data, the data of at least one annotation AN concerning this medical finding, and the character string having undergone associating operation. More specifically, the processing unit 13 associates a hyperlink linking the medical image IM and a hyperlink linking the annotation AN with the character string. The storage unit 11 stores the data of the medical image IM, the data of the annotation AN, and the character string in association with each other. Note that a plurality of annotations may be associated with one character string. The processing of associating the medical image data, the data of at least one annotation AN concerning this medical finding, and the key image having undergone associating operation corresponds to the processing of allocating a plurality of annotations to a plurality of groups in the first and second embodiments. That is, one medical finding corresponds to a group in the first and second embodiments.

Note that as a hyperlink linking the above medical image, for example, a file path in which the medical image is archived is used. If the storage format of an annotation is the DICOM overlay format, as a hyperlink linking the annotation, the address of the target annotation in DICOM overlay data or the ordinal number of the target annotation in annotation attaching operation by the user or a combination thereof is used. If the storage format of an annotation is the DICOM GSPS format, as a hyperlink linking the annotation, the address of the target annotation in DICOM GSPS data or the ordinal number of the target annotation in annotation attaching operation by the user or a combination thereof is used.

Upon completing the interpretation in the examination, the user executes confirming operation for the medical finding report via the operation unit 14. The confirming operation corresponds to, for example, the operation of pressing the confirmation button displayed on the display window via the operation unit 14. The control unit 15 performs steps SA3 to SA9 described above in response to the confirming operation performed for a medical finding report. More specifically, the processing unit 13 generates the storage data (DICOM overlay data or DICOM GSPS data) of an annotation for each group (medical finding). The storage unit 11 then stores the generated storage data of the annotation in association with medical image data and key image data or a character string on a group basis. The transmission/reception unit 16 transmits the storage data of each annotation, the medical image data, and the key image data or character string to the medical image archiving apparatus 4 together with a storage request. A transmission/reception unit 21 of the medical image archiving apparatus 4 receives the transmitted storage data of each annotation, medical image data, and key image data or character string. The storage unit 11 associates the storage data of each annotation with the medical image data and the key image data or character string on a group basis. A saving unit 22 saves them. The storage unit 11 and the medical finding report archiving apparatus 7 store the data of the completed medical finding report.

With this operation, the control unit 15 terminates the medical finding report creation processing according to the third embodiment.

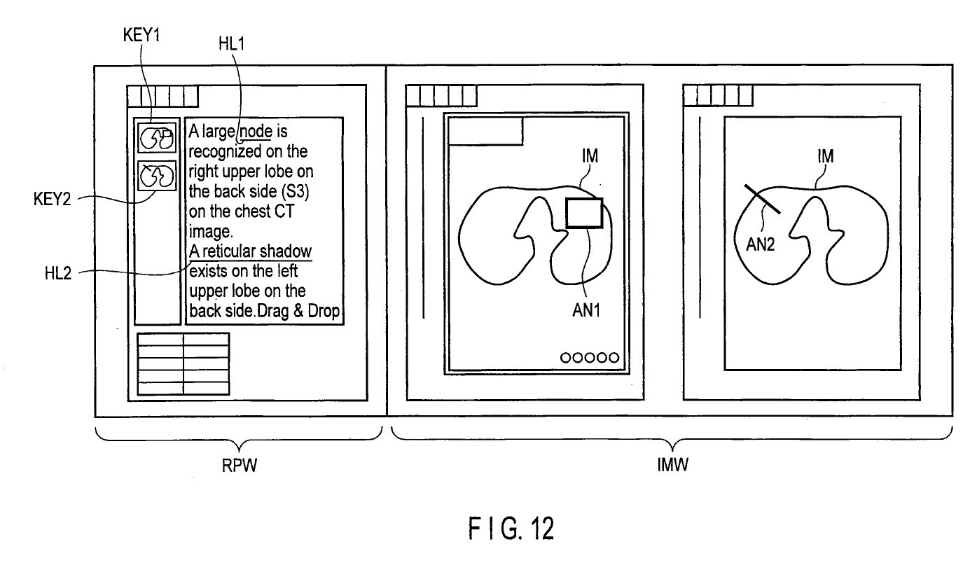

Medical finding report reference processing will be described next with reference to FIG. 12. In the medical finding report reference processing, first of all, the user selects a medical finding report via the operation unit 14. The control unit 15 causes the transmission/reception unit 16 to issue a request for the selected medical finding report in response to the operation of selecting the medical finding report. The transmission/reception unit 16 transmits the transmission request for the selected medical finding report to the medical finding report archiving apparatus 7. In response to the transmission request, the medical finding report archiving apparatus 7 transmits the corresponding medical finding report to the medical image display apparatus 6. The transmission/reception unit 16 of the medical image display apparatus 6 receives the transmitted medical finding report. The display unit 12 then displays the report on the window RPW.

Note that a medical finding report is acquired from the medical finding report archiving apparatus 7. However, this embodiment is not limited to this. For example, a medical finding report may be read out from the storage unit 11 of the medical image archiving system 5 and displayed on the display unit 12.

The display unit 12 displays, on the medical finding report, the key image generated in the process of creating the medical finding report and medical findings. Referring to FIG. 12, the display unit 12 displays a key image KEY1 corresponding to an annotation AN1, a key image KEY2 corresponding to an annotation AN2, a character string (“node” in FIG. 12) HL1 corresponding to the annotation AN1, and a character string (“reticular shadow” in FIG. 12) HL2 corresponding to the annotation AN2. A hyperlink linking the medical image data to the storage data of the annotation AN1 is embedded in the character string HL1. Likewise, a hyperlink linking the medical image data to the storage data of the annotation AN2 is embedded in the character string HL2.

The user performs displaying operation for the medical image and an annotation concerning a target medical finding via the operation unit 14 to check the medical image as a basis of the medical finding. The display operation corresponds, for example, the operation of clicking a character string corresponding to a target medical finding or a key image with the mouse of the operation unit 14. The transmission/reception unit 16 acquires the medical image data and the storage data of the annotation which are linked to each other by the hyperlink embedded in the character string having undergone displaying operation from the medical image archiving apparatus 4 in response to the execution of displaying operation. If the character string HL1 is clicked, the data of the medical image IM and the storage data of the annotation AN1 which are linked to each other by the hyperlink embedded in the character string HL1 are acquired from the medical image archiving apparatus 4. Likewise, if the key image KEY1 is clicked, the data of the medical image IM and the storage data of the annotation AN1 which are linked to each other by the hyperlink embedded in the key image KEY1 are acquired from the medical image archiving apparatus 4. Note that if the storage data of a plurality of annotations are linked to the hyperlink embedded in a clicked character string, the storage data of these annotations are acquired from the medical image archiving apparatus 4.

The processing unit 13 performs superimposition processing for the acquired medical image data and the storage data of the annotation belonging to each medical finding (group) to generate the data of the superimposed image of the acquired medical image data and the annotation belonging to each medical finding. The display unit 12 displays the superimposed image corresponding to the generated data. If, for example, the character string HL1 is clicked and the annotation AN1 is acquired, the annotation AN1 is superimposed and displayed on the medical image IM, as shown in FIG. 12. In addition, if the character string HL2 is clicked and the annotation AN2 is acquired, the annotation AN2 is superimposed and displayed on the medical image IM, as shown in FIG. 12. Furthermore, if a character string in which a hyperlink to which the data of a plurality of annotations are linked is embedded is clicked and a plurality of annotations 1 are acquired, the acquired annotations are superimposed and displayed on the medical image. The user refers to the superimposed image displayed by the display unit 12.

With this operation, the control unit 15 terminates the medical finding report reference processing according to the third embodiment.

As described above, the medical image archiving system 5 according to the third embodiment includes the display unit 12, the processing unit 13, and the storage unit 11. The display unit 12 displays a medical image on which a plurality of annotations are superimposed. The processing unit 13 allocates a plurality of annotations to a plurality of groups (medical findings). For example, the processing unit 13 allocates the plurality of annotations to a plurality of groups based on at least one of the anatomical region to which each annotation is attached, the medical finding indicated by each annotation, the input order of the respective annotations, and the position of each annotation on the medical image. The processing unit 13 creates a medical finding report concerning a medical image in accordance with the instruction issued by the user via the operation unit 14. In this case, the processing unit 13 associates, for each group, a key image clinically corresponding to each group or a character string of a medical finding with medical image data and the storage data of an annotation belonging to each group. The storage unit 11 stores the storage data of an annotation belonging to each of a plurality of groups, medical image data, and a key image or a character string of a medical finding on a group basis.

With this arrangement, the medical image archiving system 5 according to the third embodiment can allocate a plurality of annotations to a plurality of groups each having a clinically common characteristic to allow to store and read out annotations on a group basis. The medical image archiving system 5 can associate the data of an annotation belonging to each group with a medical finding report in a desired format (a key image or hyperlink) and store them. When, therefore, the user or others refer to the medical image and the medical finding report again, the user selects a group of interest (e.g., a key image or character string) of a plurality of groups to allow to display a medical image as a basis for the medical findings written on the medical finding report and annotations indicating the medical findings on the same medical image in a discriminated form. This allows the user to easily and clearly grasp the region indicated by each medical finding of the medical finding report.

Note that the arrangement of the medical image archiving system 5 according to the third embodiment is not limited to the above arrangement. For example, the medical image archiving system 5 may not include the medical finding report archiving apparatus 7. In this case, the saving unit 22 of the medical image archiving apparatus 4 may save the medical finding report. In this case, the transmission/reception unit 16 of the medical image display apparatus 6 transmits a transmission request for the medical finding report to the medical image archiving apparatus 4. The transmission/reception unit 21 of the medical image archiving apparatus 4 receives the transmission request from the medical image display apparatus 6. In response to the transmission request, the transmission/reception unit 21 reads out the medical finding report from the saving unit 22 and transmits the report to the medical image display apparatus 6.

According to the third embodiment, therefore, it is possible to improve the accuracy and efficiency of interpretation and diagnosis of a medical image attached with a plurality of annotations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image display apparatus comprising:
a display unit configured to display a medical image on which a plurality of annotations are superimposed;
an allocation unit configured to allocate the plurality of annotations to a plurality of groups; and
a storage unit configured to store data of at least one annotation belonging to each of the groups in association with data of the medical image on a group basis.

2. The medical image display apparatus of claim 1, wherein the allocation unit allocates the annotations to the groups based on at least one of an anatomical region to which an annotation is attached, a medical finding indicated by an annotation, an input order of annotations, and a position of an annotation on the medical image.

3. The medical image display apparatus of claim 1, wherein the display unit selectively reads out at least one annotation belonging to a group, of the groups, which is desired by a user from the storage unit and superimpose the annotation on the medical image while displaying the medical image and the annotation.

4. The medical image display apparatus of claim 1, wherein the data of the annotation comprises DICOM overlay data.

5. The medical image display apparatus of claim 4, wherein the storage unit embeds data of at least one annotation belonging to each of the groups as DICOM overlay data in a medical image file including the data of the medical image.

6. The medical image display apparatus of claim 1, wherein the data of the annotation comprises DICOM GSPS (Gray Scale Presentation State) data.

7. The medical image display apparatus of claim 6, wherein the storage unit embeds data of at least one annotation belonging to each of the groups as DICOM GSPS data in a medical image file including the data of the medical image or another file associated with the medical image file.

8. The medical image display apparatus of claim 1, further comprising a creation unit configured to create a medical finding report concerning the medical image in accordance with an instruction from a user, the creation unit associating, for each of the groups, the data of the medical image and at least one annotation belonging to the group with a key image clinically corresponding to the group or a character string of a medical finding.

9. The medical image display apparatus of claim 8, wherein the display unit reads out, from the storage unit, data of a medical image associated with a character string, of a plurality of character strings written on the medical finding report, which is desired by a user and data of an annotation, and superimposes the annotation on the medical image while displaying the medical image and the annotation.

10. The medical image display apparatus of claim 8, wherein the display unit reads out, from the storage unit, data of a medical image associated with a key image, of a plurality of key images attached to the medical finding report, which is desired by a user and data of an annotation, and superimposes the annotation on the medical image while displaying the medical image and the annotation.

11. A medical image archiving system comprising a medical image display apparatus configured to display a medical image and a medical image archiving apparatus connected to the medical image display apparatus via a network, the medical image display apparatus comprising
a display unit configured to display a medical image on which a plurality of annotations are superimposed,
an allocation unit configured to allocate the plurality of annotations to a plurality of groups, and
a transmission unit configured to transmit data of the medical image and data of the annotations sorted into the groups to the medical image archiving apparatus, and
the medical image archiving apparatus comprising
a reception unit configured to receive the data of the medical image and the data of the annotations from the medical image display apparatus, and
a storage unit configured to store data of at least one annotation belonging to each of the groups in association with the data of the medical image on the group basis.

12. The medical image archiving system of claim 11, wherein the medical image display apparatus further comprises a creation unit configured to create a medical finding report concerning the medical image in accordance with an instruction from a user, the creation unit associating, for each of the groups, the data of the medical image and the at least one annotation belonging to the group with a key image clinically corresponding to the group or a character string of a medical finding.
